(19) United States
(12) Patent Application Publication
(10) Pub. No.: US 2008/0251050 A1
(43) Pub. Date: Oct. 16, 2008

(54) Rapid-fire rapid-response power conversion system

(76) Inventors: Stephen C. Jacobsen, Salt Lake City, UT (US); Marc Olivier, Sandy, UT (US)

Correspondence Address: THORPE NORTH & WESTERN, LLP., P.O. Box 1219, SANDY, UT, 84091-1219, US

(21) Appl. No.: 12/080,805

(22) Filed: Apr. 4, 2008

Related U.S. Application Data
(60) Provisional application No. 60/922,241, filed on Apr. 5, 2007.

(51) Int. Cl. F02B 71/04

(52) U.S. Cl. 123/46 R

(57) ABSTRACT

A rapid-fire external compression engine having an intake device configured to introduce a pre-compressed fuel-oxidizer mixture from an external source into a combustion chamber having a low-inertia rapid response component. The rapid response component is configured to extract a high percentage of the energy derived from the combustion of the pre-compressed fuel-oxidizer mixture and convert it into mechanical work, which may then be transformed via a variety of methods into usable output power to operate a powered device.

### RELATED APPLICATIONS

This application claims the benefit of U.S. Provisional Application Ser. No. 60/922,241, filed Apr. 5, 2007, and entitled, “Rapid-Fire Rapid-Response Power Conversion System,” which is incorporated by reference in its entirety herein.

### FIELD OF THE INVENTION

The present invention relates generally to power conversion systems that utilize a combustion engine to generate energy from a fuel source and a power conversion device configured to extract the generated energy and convert it into usable energy or work.

### BACKGROUND OF THE INVENTION AND RELATED ART

There are many different types of primary power sources available that convert fossil and other fuels into usable energy or power designed to perform work for one or more purposes. Some of the applications utilizing such power sources include everyday common items, such as motor vehicles, lawn mowers, generators, hydraulic systems, etc. Perhaps the best known example of a primary power source is the conventional internal combustion (“IC”) engine, which converts the energy obtained or generated from the combustion of fossil fuel into usable energy, such as mechanical energy, electrical energy, hydraulic energy, etc. Indeed, a conventional IC engine has many uses both as a motor and as a power source used to drive or actuate various items, such as a pump. Converting fossil fuels into usable energy is also accomplished in large electricity plants, which supply electric power to power grids accessed by thousands of individual users.

While primary power sources have been successfully used to perform the several functions described above, they have not been successfully used independently in many applications because of their relatively slow response characteristics. Although a large amount of energy is contained within a single drop of fuel, IC engines are particularly problematic in powering small devices, and particularly robotic devices and other similar systems that utilize a feedback loop to make real time adjustments in the movement of the mechanical structure being driven. In a robotic or any other system requiring rapid response, the power source typically must be able to generate output power that is capable of instantaneous or near instantaneous correction, as determined by the feedback received, that is necessary to maintain proper operation of the robotic device. Primary power sources utilizing fossil fuels for energy production have proved difficult or largely unworkable in these environments.

The response speed or response time of a power source functioning within a mechanical system, which response time is more accurately referred to as the system's bandwidth, is an indication of how quickly the energy produced by the power source can be converted, accessed, and utilized by an application. One example of a rapid-response power system is a hydraulic power system. In a hydraulic system, energy from any number of sources can be used to pressurize hydraulic fluid, which pressurized fluid is stored in an accumulator for later use. This is what is meant by charging the accumulator. The energy contained in the stored pressurized fluid can be accessed almost instantaneously by opening a valve in the system and releasing the fluid in the accumulator for the purpose of performing work, such as extending or retracting a hydraulically driven actuator. The response time of this type of hydraulic system is very rapid, on the order of a few milliseconds or less.

An example of a relatively slow response power conversion system is the IC engine, as discussed above. The accelerator on a vehicle equipped with a conventional IC engine controls the rotational speed of the engine, measured in rotations or revolutions per minute (“rpm”). When power is desired, the accelerator is activated and the engine increases its rotational speed accordingly. Setting aside impedance factors, the engine cannot reach the desired change in a very rapid fashion due to several inertial forces internal to the engine and the nature of the combustion process. If the maximum rotational output of an engine is 7000 rpm, then the time it takes for the engine to go from 0 to 7000 rpm is a measure of the response time of the engine, which can be a few seconds or more. Moreover, if it is attempted to operate the engine repeatedly in a rapid cycle from 0 to 7000 rpm and back to 0 rpm, the response time of the engine slows even further as the engine attempts to respond to the cyclic signal. In contrast, a hydraulic cylinder can be actuated in a matter of milliseconds or less, and can be operated in a rapid cycle without compromising its fast response time.

For this reason, many applications utilizing slow response primary power systems (such as an IC engine) require the energy produced by the primary power source to be stored in another, more rapidly responsive energy system capable of holding the energy in reserve so that the energy can be accessed later instantaneously. One example of such an application is heavy earth moving equipment, such as backhoes and front end loaders, which utilize the hydraulic pressure system discussed above. Heavy equipment is generally powered by an IC engine, usually a diesel engine, which supplies ample power for the maneuvering and driving of the equipment, but is incapable of meeting the energy response requirements of the various functional components, such as the bucket or backhoe. By storing and amplifying the power from the IC engine in the hydraulic system, the heavy equipment is capable of producing, in a rapid response, great force with very accurate control. However, this versatility comes at a cost. In order for a system to be energetically autonomous and be capable of rapid, precise control, more component parts or structures are required, thus increasing the weight of the system and its operating costs.

Another example of a rapid-response power supply is an electrical supply grid or electric storage device such as a battery. The power available in the power supply grid or battery can be accessed as quickly as a switch can be opened or closed. A myriad of motors and other applications have been developed to utilize such electric power sources. Stationary applications that can be connected to the power grid can utilize direct electrical input from the generating source. However, in order to use electric power in a system without tethering the system to the power grid, the system must be configured to use energy storage devices such as batteries, which can be very large and heavy. As modern technology moves into miniaturization of devices, the extra weight and volume of the power source and its attendant conversion hardware are becoming major hurdles against meaningful progress.

The complications inherent in using a primary power source to power, a rapid response source become increasingly problematic in applications such as robotics. In order for a robot to accurately mimic human movements, the robot must be capable of making precise, controlled, and timely movements. This level of control requires a rapid response system such as the hydraulic or electric systems discussed above. Because these rapid response systems require power from some primary power source, the robot must either be part of a larger system that supplies power to the rapid response system or the robot must be directly equipped with one or more heavy primary power sources or electric storage devices. Ideally, however, robots and other applications should have minimal weight, and should be energetically autonomous, not tethered to a power source with hydraulic or electric supply lines. To date, however, technology has struggled to realize this combination of rapid response, minimal weight, effective control, and autonomy of operation.

### SUMMARY OF THE INVENTION

In light of the problems and deficiencies inherent in the prior art, the present invention seeks to overcome these by providing a power conversion system configured to provide rapid generation of energy coupled with rapid extraction of this energy for conversion into output power for the operation of one or more devices.

To achieve the foregoing objects, and in accordance with the invention as embodied and broadly described herein, the present invention features a rapid-fire rapid-response power conversion system comprising (a) a rapid-fire external compression/combustion engine comprising, in one exemplary embodiment, a combustion chamber having a combustion portion proximate to the head end of the combustion chamber, a controllable intake device in fluid communication with a source of pressurized combustive fluid which is configured to inject the combustive fluid into the combustion portion through at least one controllable fluid intake port, an ignition source controlled by a controller for selectively timing a combustion of the combustive fluid, wherein the combustion functions to generate energy in the chamber, a rapid-response component, situated adjacent and fluid communication with the combustion portion of the chamber and having a lower inertia to facilitate a rapid response to the combustion, wherein the rapid-response component is configured to extract a portion of the energy generated from the combustion in the combustion chamber and convert it into mechanical work, and an out-take port for purging combusted exhaust gasses from the chamber following combustion; (b) an energy transfer component configured to receive the mechanical work in the rapid-response component and convert it into usable output power for operating a device or system, such as a hydraulic pump.

The external compression engine described above achieves its rapid response characteristic by physically removing the compression cycle from the combustion chamber of the engine. Instead of introducing a fuel and an oxidizer in the combustion chamber during a suction stroke of a piston and then compressing the mixture during a compression stroke, the fuel and oxidizer are instead pre-mixed and pre-compressed into a pressurized combustive fluid at a location external to the engine. The fuel/oxider mixture is externally pre-compressed to a pressure greater than or equal to the maximum pre-ignition pressure inside the combustion chamber, to allow for a slight pressure drop as the mixture passes through the intake device into the combustion chamber.

Separating the compression mechanism from the combustion mechanism eliminates the traditional suction and compression strokes of a four-cycle IC engine, and the engine is reduced to only the components required for the performance of the combustion and exhaust strokes. Thus, the engine of the present invention eliminates the need for a crankshaft and all its associated components, such as bearings, connecting rods, crossheads and the flywheel, as the crankshaft is no longer required to transfer energy of compression into the pre-combustion products before receiving the output energy derived from the combustion process itself. The resulting external compression engine is simpler, smaller, lighter in weight and far more responsive than conventional IC engines, and is ideal for use in robots and other applications requiring minimal weight, rapid response, effective control, and autonomy of operation.

Moreover, the present invention is not limited to the use of combustive fluids to create a reaction which drives the engine. While the pressurized combustive fluid will often be a combination of fuel and oxidizer, such as a pre-compressed air/fuel mixture, other types of fuels may also be used to generate a reaction. Monopropellants, hypergolic bi-propellants or other fuels that release heat without combustion are likewise useful sources of energy, and may be applied by incorporating a catalyst to trigger the reaction or enhance the rate of energy release. Under such circumstances the rapid-fire external compression engine then comprises a reaction chamber having a reaction portion proximate to the head end of the reaction chamber, and a controllable intake device which is configured to inject a pressurized reactive fuel into the reaction portion. An example of a pressurized reactive fuel is concentrated hydrogen peroxide, which after injection into the reaction portion rapidly decomposes to produce a very hot gas comprised primarily of steam and oxygen.

Regardless of the type of fuel or reaction, the present invention further features a powered actuator system comprising (a) a rapid-fire external compression engine configured to generate energy from a pressurized combustive fluid injected into a combustion portion proximate to the head end of a combustion chamber, with a rapid-response component, also known as a parasite piston, in fluid communication with the combustion chamber and adjacent the combustion portion, wherein the rapid-response component is configured to extract at least a portion of the energy generated during the combustion and convert it into mechanical work; (b) an energy transfer component configured to receive the mechanical work and to convert it into usable output power; (c) a pump operably powered by the energy transfer component, wherein the pump is configured to displace hydraulic fluid through a pressure line; (d) a pressure control valve in fluid communication with the pump through the pressure line, wherein the pressure control valve is configured to selectively regulate the displacement and pressure of the hydraulic fluid with respect to an actuator; and (e) an actuator coupled to a load, wherein the actuator is in fluid communication with the pressure control valve and is configured to drive the load according to the pressurized hydraulic fluid received and in response to the imposed dynamics of the load.

The present invention also allows for a number of rapid-fire rapid-response power conversion devices to be installed on a common pressurized combustive fluid bus and share a common compressor. For instance, in a powered hydraulic actuator system that uses several actuators, one or more rapid-fire rapid-response power conversion devices can be distributed near each actuator and utilized to generate pressurized hydraulic fluid as needed by that actuator. This results in significantly improved overall conversion efficiencies when compared to conventional servo-hydraulic systems, which use distributed servo-valves to control the pressure and flow to an actuator by throttling down the pressurized hydraulic fluid in the hydraulic supply bus. The present invention simplifies the system and improves efficiency by simultaneously serving the functions of the engine, the hydraulic pump and the servo-valve.

The present invention still further features a method for powering a device from a rapid-fire external compression engine, wherein the method comprises (a) producing an external supply of a pressurized combustive fluid, (b) introducing the pressurized combustive fluid into a combustion portion proximate to the head end of a combustion chamber, with a rapid-response component, also known as a parasite piston, in fluid communication with the combustion chamber and adjacent the combustion portion, wherein the rapid-response component is configured to extract at least a portion of the energy generated during the combustion and covert it into mechanical work, (c) initiating a combustion in the pressurized combustive fluid to generate energy, (d) extracting a portion of the energy generated from the combustion by causing the rapid-response component to perform mechanical work by powering the device; and (e) purging the exhaust products from the combustion chamber to draw the rapid-response component back toward the head end of the combustion chamber.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a schematic side view of a rapid-fire rapid-response power conversion system according to an exemplary embodiment of the present invention;

FIG. 2 illustrates an expanded schematic side view of a rapid-fire rapid-response power conversion system according to the exemplary embodiment shown in FIG. 1;

FIG. 3a illustrates an exemplary power conversion system for extracting the energy generated by the external compression engine;

FIG. 3b illustrates another exemplary power conversion system for extracting the energy generated by the external compression engine;

FIG. 4 illustrates a block diagram associated with various partial schematic side views, depicting various forms of energy transfer through an energy transfer component of the rapid-response power conversion system;

FIG. 5 illustrates a graphical representation of the physical response characteristics of the rapid-fire external compression engine in terms of time, temperature inside the combustion chamber and displacement of the parasite piston, according to an exemplary embodiment of the present invention;

FIG. 6a illustrates the response characteristics of a conventional IC engine;

FIG. 6b illustrates the superior physical response characteristics, such as a wider bandwidth and the capability of pulse width modulation, provided by an exemplary embodiment of the present invention over the response characteristics of a conventional IC engine;

FIG. 7 illustrates a block diagram associated with various partial schematic side views, depicting the use of an exemplary rapid-fire rapid-response power conversion system to power a hydraulic pump used to provide hydraulic fluid to a pressure control valve configured to regulate the pressure and flow of hydraulic fluid in and out of an actuator attached to a load; and

FIG. 8 is a flowchart depicting a method of a rapid-fire external compression engine, according to an exemplary embodiment of the present invention.

### DETAILED DESCRIPTION OF EXEMPLARY EMBODIMENTS

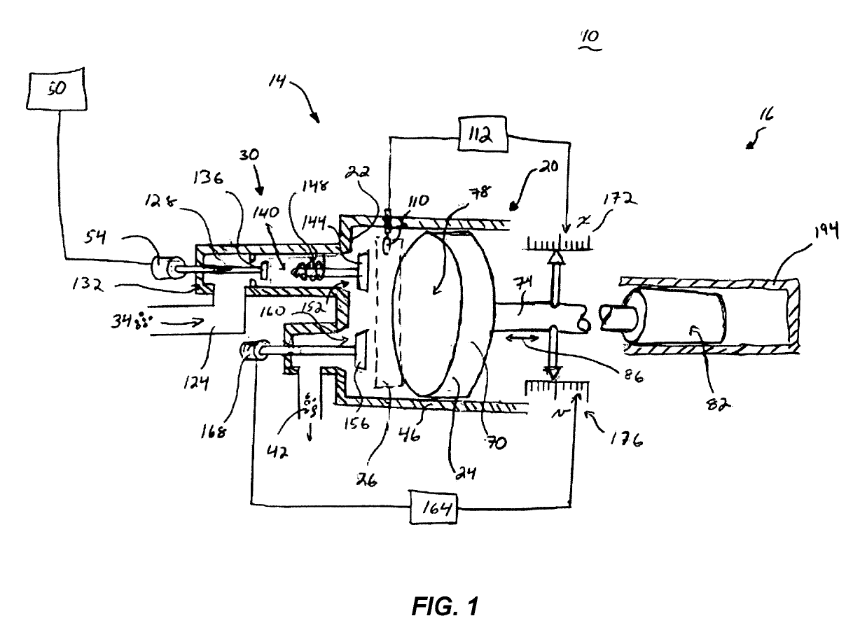

The following detailed description of exemplary embodiments of the invention makes reference to the accompanying drawings, which form a part thereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 7, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and system for generating energy from a rapid-fire external compression engine and for converting that energy, through means of a unique rapid-response power conversion system, into usable energy or power to operate a powered device at high energy bandwidths. The rapid-fire external compression engine is a source of a high-powered energy that can be operated continuously or in selective bursts or pulses by controlling the amount of pre-compressed fuel/oxidizer mixture injected into the combustion chamber.

Referring now to FIG. 1, illustrated is a simplified schematic view of a rapid-fire rapid-response power conversion system according to one exemplary embodiment of the present invention. Specifically, FIG. 1 illustrates one exemplary embodiment of a rapid-fire rapid-response power conversion system 10 as comprising a rapid-fire external compression and combustion engine 14, a rapid-response component 24 and a power conversion device 16. The external compression engine comprises a unique two-stroke combustion/exhaust cycle engine designed to operate with the rapid-response power conversion system as described herein. Other types of engines are described in earlier applications for patent by the inventor as identified above.

The rapid-fire external compression engine is a two-stroke combustion/exhaust cycle engine that may be operated at will so that combustion occurs to drive a rapid-response component 24. What is meant by “rapid-fire” is the ability of the external compression engine to selectively and continuously drive the rapid-response component with very short combustion cycles by using an intake device 30 to control the injection of a pre-compressed fuel/oxidizer mixture 34 into the combustion portion 26 of the engine, which is proximate to the head end 22 of a combustion chamber 20.

What is meant by “external compression” is that the fuel and oxidizer are pre-mixed and pre-compressed into a pressurized combustive fluid at a location external to the engine, for the purpose of eliminating the traditional suction and compression strokes of a four-cycle IC engine and reducing the engine to only the components required for the performance of the combustion and exhaust strokes. In other words, the present invention rapid-fire compression engine is not required to perform additional compression of the fuel/oxidizer mixture once introduced into the combustion chamber. The fuel/oxider mixture 34 may be externally pre-compressed to a pressure greater than or equal to the maximum pre-ignition pressure inside the combustion chamber, to allow for a slight pressure drop as the mixture passes through the intake device 30 into the combustion chamber 20. In an alternative embodiment, the fuel and oxidizer may be separately compressed and combined together within the intake device 30, or both may be injected separately at pressure into the combustion chamber 20.

Irrespective of the method of mixing the pre-compressed fuel and oxidizer and introducing the mixture into the combustion chamber, the engine of the present invention does not further compresses or perform work on the fuel/oxider mixture once it enters the combustion chamber. Instead, the pressure of the pre-compressed fuel/oxidizer mixture is suitable to facilitate combustion without the need for further compression within the combustion chamber, and the engine is configured to output the energy generated during the combustion of the mixture.

In an exemplary embodiment of the present invention, the rapid-response component 24 may comprise a parasite piston 70, also referred to herein as the energy extraction piston. What is meant by “parasite” is that the piston is configured to predominately extract energy from the system. Unlike the piston inside a conventional internal combustion (“IC”) engine, which both inputs energy into the system by compressing the fuel/oxidizer mixture during the compression stroke and receives energy from the system during the combustion stroke, the parasite piston of the present invention only receives energy during the combustion stroke, since the fuel/oxidizer mixture is pre-compressed in a separate device external to the external compression engine. The parasite piston is also be configured to have a much lower inertia than a piston in a conventional internal compression engine which allows it to respond more quickly to the forces generated during the combustion cycle.

The exemplary rapid-fire external compression engine 14 shown in FIG. 1 comprises a single combustion chamber 20 separated from an intake device 30 by an intake valve 144. The combustion chamber encloses the rapid-response component 24, or in this embodiment the parasite piston 70. The parasite piston 70 includes a face or energy receiving portion 78 that is adjacent or juxtaposed to the combustion portion 26, which is an enclosed volume located proximate to the head end 22 of the combustion chamber. Extending from the parasite piston 70 is a piston rod 74 that is coupled to an energy transfer component 82 of the power conversion device 16, otherwise known generally as a powered device configured to do or perform work. In an inactive position, the energy receiving portion 78 of the parasite piston 70 may be biased in a substantially sealed, retracted position against a lip (not shown) or some other suitable sealing means, and biased by a spring or by another suitable biasing force, such as a pressure reservoir, so that the parasite piston is supported in a biased position prior to the introduction of the fuel/oxidizer mixture 34 into the combustion chamber.

Before starting the rapid-fire external compression engine 14, a pre-compressed fuel/oxidizer mixture 34 is first supplied to the intake device 30 through fuel/oxidizer supply bus 124. The fuel/oxidizer mixture fills the control chamber 128, but is prevented from passing into the intake chamber 140 and combustion chamber 20 by fuel control valve 136. Before operation, intake valve 144 is biased in the open position by means of biasing component 148, which will allow the pre-compressed fuel/oxidizer mixture to flow freely from the control chamber, through the intake chamber and into the combustion chamber once the control valve is opened. In the aspect shown, the biasing component is a mechanical device, but in another aspect it may be an electronic biasing component or even an actively controlled valve actuator.

To operate the rapid-fire external compression engine 14, fuel controller 50 signals the fuel control actuator 54 to open control valve 136. In the aspect shown, the fuel control valve is an electrically controlled valve, but in another aspect it may be a mechanically controlled valve. The pre-compressed fuel/oxidizer mixture 34 flows through the intake chamber 140 into the head end 22 of the combustion chamber 20 and begins to fill the combustion portion 26. As the combustion portion fills with the pre-compressed gases, a force is impressed upon energy receiving face 78 which causes parasite piston 70 to move linearly away from the head end of the combustion chamber. This movement is monitored by the ignition controller 112 through a piston displacement sensor 172. When the ignition controller senses that the parasite piston has moved to a specified position corresponding to a specific charge of the pre-compressed fuel/oxidizer mixture, the controller ignites the combustive fluid with ignition source 110. If the fuel/oxidizer mixture is further comprised of an air/fuel mixture, the ignition source may be of the spark ignition type. However, it may also comprise any type of ignition source known to a person having skill in the art that is capable of initiating combustion in the combustive fluid.

Although the amount of fuel/oxidizer charge is normally optimized for greatest efficiency, the ignition controller can vary the charge continuously. When there is a demand for more power, a larger charge of the pre-compressed fuel/oxidizer mixture can be introduced into the engine by delaying ignition until the displacement sensor senses that the parasite piston has moved to a position further away from the head end of the combustion chamber.

In an alternative embodiment, ignition of the fuel/oxidizer charge may not be triggered off the displacement of the parasite piston 70. Instead the ignition can be initiated based on the volume or amount of the fuel/oxidizer mixture 34 which has passed into the combustion chamber 20 as measured with a flow meter (not shown) in the inlet device 30 or timed with a controller. The ignition can also be initiated based on the pre-combustion pressure inside the combustion chamber 20 as measured with a pressure sensing device (not shown), in which case the parasite piston 70 can be temporarily fixed near the head end 22 of the combustion chamber 20 to maintain a combustion portion 26 having a constant volume but increasing pressure as it begins to fill with the pre-compressed fuel/oxidizer mixture.

Upon combustion, the parasite piston 70 is quickly accelerated to maximum speed by the expanding combustion gases. The force generated by the external compression engine is countered by the opposing load impressed by the energy transfer component 82 of the power conversion device 16, causing the energy generated from the combustion to be extracted and converted into usable mechanical work. As the energy is extracted, the velocity of the parasite piston falls toward zero. This drop in velocity is monitored by an exhaust valve controller 164 through a piston velocity sensor 176. As the velocity of the parasite piston approaches zero, the exhaust valve controller signals an exhaust valve actuator 168 to open an exhaust valve 156, which allows the combustion gases 42 to escape through the exhaust port 160. This has the affect of immediately drawing back the parasite piston to its starting position. In the aspect shown, the exhaust valve is an electrically controlled valve, but in another aspect it may be a mechanically controlled valve. Also in the aspect shown, the exhaust port is located in the head end 22 of the combustion chamber 20, but in another aspect the exhaust port or ports may be located in the sidewalls 46 of the combustion chamber. When the parasite piston reaches it's starting position back near the head end of the combustion chamber, its velocity is again zero and the exhaust valve controller closes the exhaust valve.

The rise in pressure resulting from the combustion of the fuel/oxidizer mixture is sufficient to overcome the force generated by the biasing component 148, pushing shut the intake valve 144 and sealing the intake chamber 140 from the head end 22 of the combustion chamber 20 for the duration of the combustion stroke, also referred to herein as the power stroke. The greater pressure in the combustion chamber remains high enough to keep the intake valve closed until nearly all the exhaust gases have been purged at the end of exhaust stroke, at which time the biasing component causes the intake valve to spring back open. As long as the fuel controller 50 holds open the fuel control valve 136, when the intake valve re-opens the pre-compressed fuel/oxidizer mixture 34 will immediately begin to flow back into head end of the combustion chamber and the combustion process will automatically repeat itself.

One important aspect of the present invention is that the parasite piston 70 has a substantially lower inertia than that of pistons used in conventional IC engines known to one of ordinary skill in the art. Such a low-inertia parasite piston facilitates a rapid response to combustion, leading to very quick linear movement 86 of the parasite piston along the longitudinal axis of the combustion chamber. Because the inertia of the parasite piston is much lower than the inertia of a conventional IC engine piston, the parasite piston can efficiently extract a larger fraction of the energy created by the combustion before it is otherwise lost to inefficiencies inherent in conventional IC engines. In this embodiment, the energy receiving portion 78 of the parasite piston is sized, positioned and configured to react to the combustion occurring within the combustion portion 26 proximate to the head end 22 of the combustion chamber 20 so as to impart linear movement in the parasite piston which in turn conveys mechanical work to the energy transfer component 82 of the power conversion device 16.

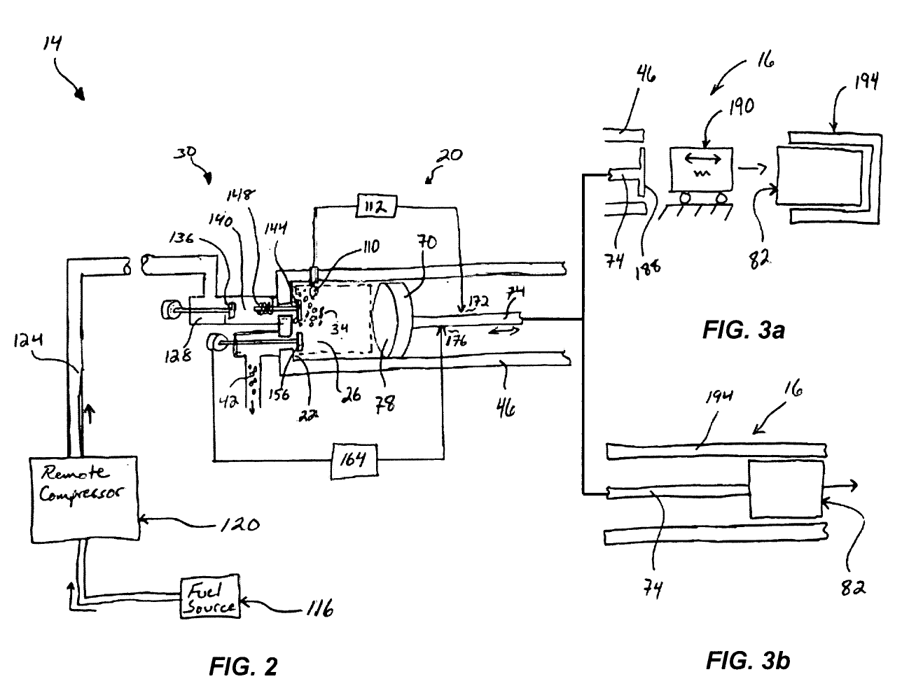

FIG. 2 further expands the embodiment of a rapid-fire rapid-response power conversion system 10 shown if FIG. 1. In this expansion, the rapid-fire external compression engine 14 is operably coupled to a remote compressor 120 that receives fuel or an oil/fuel mixture from fuel source 116. In the embodiment shown, the remote compressor combines the fuel or oil/fuel mixture with an oxidizer, such as air, and compresses them together to create a pre-compressed fuel/oxidizer mixture which is conveyed through the fuel/oxidizer bus 124 to the intake device 30. Thus, the fuel/oxidizer bus fluidly connects the remote compressor to the external compression engine. However, it is also conceived that in other equally valid embodiments of the present invention the fuel may be injected into the fuel/oxidizer bus downstream of the compressor, within the intake device itself, or the fuel also may be injected or atomized directly into the combustion chamber, separate from the oxidizer.

As further illustrated in FIG. 2, the pre-compressed fuel/oxidizer mixture 34 is held in the fuel control chamber until fuel control valve 136 is caused to open via controller 50 (not shown). After the fuel control valve has opened, the pre-compressed fuel/oxidizer mixture 34 flows through the intake chamber 140, around intake valve 144 and into the combustion portion 26, located proximate to the head end 22 of the combustion chamber 20. The intake valve is normally biased in the open position by means of a biasing component 148. In the aspect shown, the biasing component 148 is a mechanical device, but in another aspect it may be an electronic biasing device or even an actively controlled valve actuator. It is also noted that the remote compressor 120 may be any type of compression system known in the art capable of supplying a compressed fuel/oxidizer mixture to a combustion chamber for the purpose of operating an external compression engine.

The combustion portion 26 of combustion chamber 20 is defined by the sidewalls 46, the head end 22, and the energy receiving side 78 of the parasite piston 70. Combustion is initiated after the parasite piston moves a specified linear distance in response to the pressure exerted by the pre-compressed fuel/oxidizer mixture, as measured by the displacement sensor 172 and monitored by ignition controller 112, which triggers combustion using the ignition source 110. Through programming of the ignition controller, the charge of pre-compressed fuel/oxidizer mixture, or pressurized combustive fluid, may be varied according to the desired power production of the rapid-fire rapid-response power conversion system 10.

FIG. 3a illustrates one exemplary type of power conversion device 16 which may be powered by the external compression engine 14. In this device, the parasite piston is not directly coupled to but is instead structurally independent from the energy transfer component 82 of the powered device 194. The parasite piston 70 operates to power the powered device 194 through its interaction with a dynamic mass structure 190. Specifically, the parasite piston includes an impact member 188 attached to or formed from the piston rod 74. The impact member is essentially an energy transfer component that, once the parasite piston is moved by the forces of combustion, impacts a dynamic mass structure, which in turn extracts the kinetic energy stored in the parasite piston. The dynamic mass structure is separate from and operates independent to both the parasite piston and the powered device. The impact causes the dynamic mass structure to displace a pre-determined distance at a given velocity, where it impacts the energy transfer component of the powered device. Upon impact, the dynamic mass structure is configured to transfer its stored kinetic energy into the energy transfer component, which then converts the kinetic energy into power that is used to operate the powered device 194. This process is repeated with each cycle of the external compression engine.

The concept of a dynamic mass structure power conversion system is more fully set forth in U.S. patent application Ser. No. 11/293,621, filed Dec. 1, 2005, and entitled “Dynamic Mass Transfer Rapid Power Conversion Device,” and is incorporated by reference in its entirety herein.

FIG. 3b illustrates another exemplary embodiment of a power conversion device 16. Unlike the embodiment of FIG. 3a where the parasite piston 70 is not directly connected to the energy transfer component, the embodiment of FIG. 3b comprises a parasite piston with a piston rod 74 that is coupled directly to the energy transfer component 82 of a powered device 194. In this more general-purpose case, the displacement of the parasite piston by the combustion functions to directly propel the powered device. In addition, the parasite piston is preferably biased toward the head end 22 of the combustion chamber 20 by the powered device.

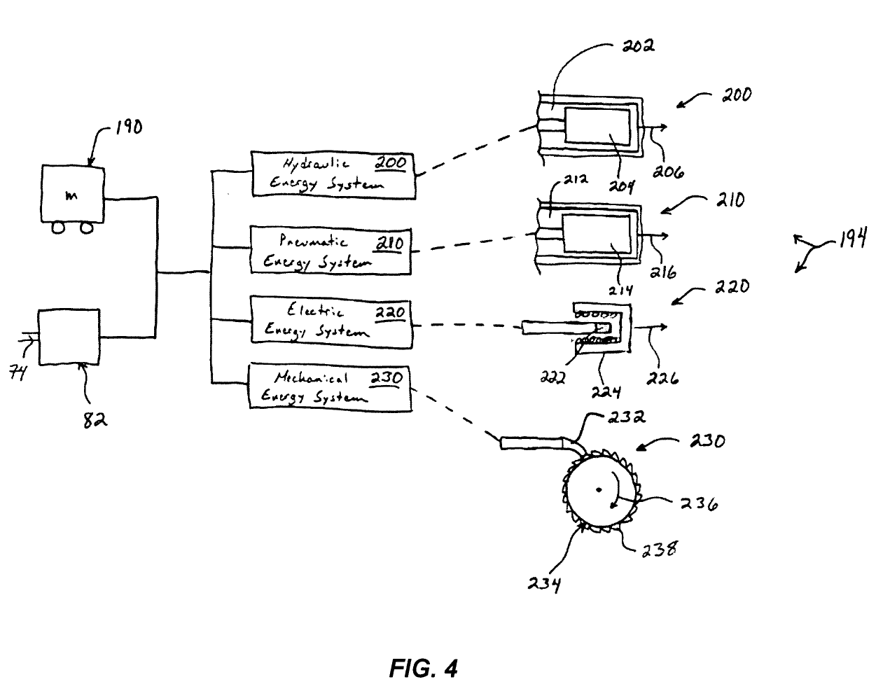

FIG. 4 illustrates different embodiments of an energy transfer component 82 used to convert the energy from the external compression engine into usable energy or work or power. The energy transfer component 82 may include and/or may be coupled with any number of energy conversion or powered devices 194. In particular, the energy transfer component 82 is configured to transfer the linear movement of and kinetic energy stored in the parasite piston 70 or the dynamic mass structure 190 to various types of usable energy, such as hydraulic energy, pneumatic energy, electric energy and/or mechanical energy. Transferring linear motion and kinetic energy into such various types of usable energy is well known in the art.

For example, in a hydraulic system 200, the linear axial motion, via the parasite piston rod 74 or the dynamic mass structure 190, of an energy transfer component such as a hydraulic piston 204 in a hydraulic chamber 202 may provide hydraulic pressure and flow 206, as is well known in the art. Similarly, in a pneumatic system 210, the parasite piston rod 74 or the dynamic mass structure 190 may provide linear motion to an energy transfer component in the form of a pneumatic piston 214 in a pneumatic chamber 212 to provide output energy in the form of pneumatic pressure and gas flow 216.

Other systems may include an electrical system 220 and a mechanical system 230. As well known in the art, in an electrical system 220, the linear motion of parasite piston rod 74 or the dynamic mass structure 190 may be interconnected to an energy transfer component in the form of an magnetic piston 222 with an armature 224 having a coil wrapped therein, wherein the magnetic piston reciprocates in the coil to generate an electrical energy output 226. Furthermore, in the mechanical system 230, linear motion from the parasite piston rod 74 or the dynamic mass structure 190 may be transferred to rotational energy 236 via the energy transfer component existing in the form of a pawl 232 configured to push against the teeth 238 of a crank shaft 234 to provide rotational energy 236. Additionally, the parasite piston rod 74 may be directly interconnected to the crankshaft 234 to provide the rotational energy 236. Other methods of converting energy will be apparent to those skilled in the art. For example, rotational electric generators, gear driven systems, and belt driven systems can be utilized by the energy transfer component 82 the present invention.

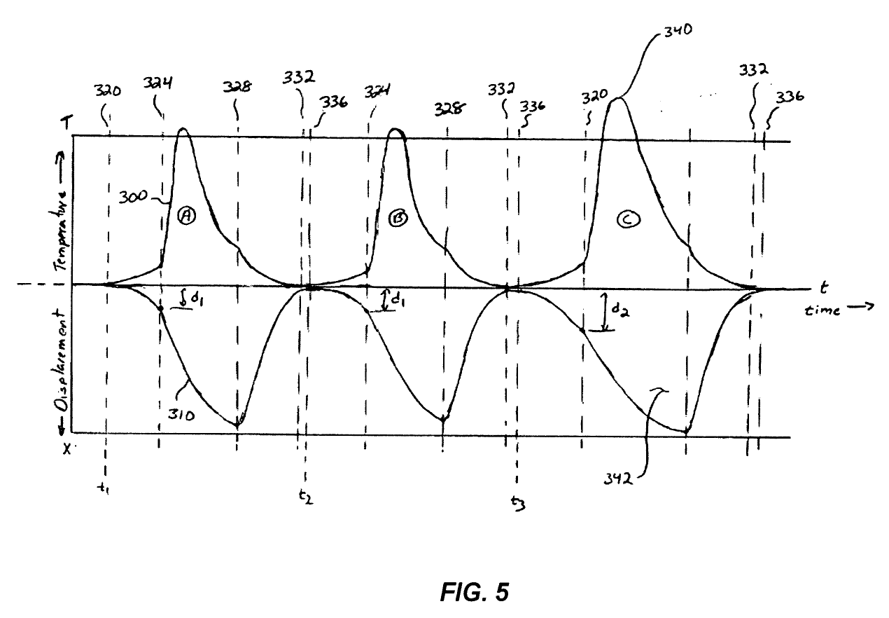

FIG. 5 illustrates a graphical representation of the physical response characteristics of the combustion chamber and parasite piston in terms of time, temperature and displacement when undergoing operation of the rapid-fire external compression engine. Specifically, line 300 is a relative indication of the rise and fall of the chamber temperature due to combustion of the pre-compressed fuel/oxidizer mixture 34, heat loss, and expansion and discharge of the exhaust gases 42, respectively, with respect to the linear displacement of the parasite piston. Line 310 is an indication of the displacement of the parasite piston 70 as it moves within the combustion chamber.

With simultaneous reference to both FIGS. 1 and 5, the external compression engine 14 is initialized in a non-operational state (t₁), with the parasite piston 70 resting in its biased position closest to intake port 152, and intake valve 144 biased in its open position. At time event 320 the fuel/oxidizer control valve 136 opens, allowing the pre-compressed fuel/oxidizer mixture 34 to flow through the intake chamber 140, past the open intake valve, and into the combustion portion 26 proximate to the head end 22 of the combustion chamber 20. As the combustion portion fills with the pre-compressed fuel/oxidizer mixture, the temperature in the combustion chamber begins to rise slightly and the pressure exerted on the parasite position causes it to displace slightly from its starting position towards position d₁. When parasite piston reaches position d₁, ignition controller 112 activates the ignition source in event 324. In the optimally designed combustion (A) that follows, the temperature in the combustion chamber spikes and then drops rapidly as the exhaust gases expand against the parasite piston. Also at event 324, the corresponding rise in pressure during combustion causes the intake valve to temporarily overcome the biasing component 148 and immediately slam shut, preventing the combustion from entering the intake chamber and igniting the gases stored within the intake device 30. The parasite piston responds by quickly moving toward the power conversion device 16, but slows down as work is performed and the combustion gases complete their expansion. Exhaust controller 164 monitors the velocity of the parasite piston, and before it drops to zero the controller opens exhaust valve 156 in event 328.

Opening exhaust valve 156 allows the exhausted gases of combustion to escape, which causes both the temperature to drop and the parasite piston to draw back to its starting position. Once the parasite piston reaches its starting position, the exhaust valve closes (event 332) and the intake valve re-opens (event 336), allowing a fresh charge of pre-compressed fuel/oxidizer mixture 34 back into combustion chamber 20. The process will repeat (B) itself continuously (starting at t₂) as long as fuel/oxidizer control valve 136 is kept in the opened position by fuel controller. This automatic rapid-fire operation of external compression engine 14, activated by simply opening the fuel/oxidizer control valve, is what gives the present invention its “machine gun” characteristic. The external compression engine will continue to run until the fuel/oxidizer control valve is closed.

The volume of the fuel/oxidizer mixture introduced into combustion portion 26 is controlled by d₁ and is optimized for maximum efficiency in normal operation based upon the chemical composition of fuel/oxidizer mixture 34, geometry of the combustion chamber 20 and physical characteristics of the parasite piston 70. However, it is foreseeable that circumstances will arise requiring greater power output, with a corresponding trade-off in lower engine efficiency. The external compression engine 14 of the present invention is able to accommodate the greater power requirement (starting at t₃) by having the ignition controller 112 adjust the ignition timing from d₁ to d₂, which results in a greater charge of the pre-compressed fuel/oxidizer mixture being introduced into the combustion portion. The stronger combustion (C) results in a higher peak temperature 340 and greater amount of work performed by the parasite piston 342, which may or may not be readily apparent by observation of the displacement of the piston, even though the load is greater.

The rapid-response external compression engine 14 of the present invention has significant advantages over conventional IC engines, which are already well established in the prior art. As is commonly known, conventional IC engines are designed to convert the thermal energy created by combustion into linear movement of a drive piston, which is in turn converted into rotational energy by means of the crankshaft. However, much of the thermal energy created in conventional IC engines is lost due to heat escaping into the engine walls surrounding the combustion chamber and residual heat retained in the exhaust gases. Even the most efficient IC engines rarely reach efficiency rates of more than 35%. Consequently, more than half of the energy available from the combusted fuel is lost in the form of heat transfer through the walls and piston via conduction and radiation, as well as heat released through the exhaust.

The heat rise and heat loss illustrated by the rising and falling of line 300, representing combustion, depicts the time during which energy is available to perform work, and is the time period in which the drive piston in a conventional IC engine should be extracting the thermal energy. However, the motion of a drive piston is keyed to the motion of the crankshaft, which cycle time is much slower than the processes of combustion and heat transfer away from the combustion chamber. As a result, most of the thermal energy generated during combustion escapes before it can be extracted as work by the drive piston in a conventional IC engine.

According to the present invention, however, the parasite piston substantially completes its useful energy extraction cycle before the heat energy has had a chance to escape. Because the response time of the parasite piston is much more rapid than a drive piston, it can convert a much greater percentage of the thermal energy into linear motion before the thermal energy is lost to the heat sink formed by the walls, primary piston, and other components of the external compression engine. For example, in a conventional IC engine running at 3000 revolutions per minute, the drive piston would complete a half-cycle (or energy extraction stroke) in approximately 10 milliseconds, or 0.010 seconds. Meanwhile, the rise and fall of combustion chamber temperature 300 associated combustion and heat loss is substantially complete within approximately 3 milliseconds, or 0.003 seconds. Because the parasite piston is operated independently of a crankshaft or other similar device and includes a substantially lower inertia, the parasite piston is free to react within a 3 millisecond response time, or even less. The parasite piston can both begin and stop extracting energy from the combustion gases of the engine within the 3 millisecond period of time when most of the energy of combustion of available. In other words, in the rapid-fire external compression engine of the present invention, the movement of the piston is de-coupled from the mechanical constraints of a crankshaft and is given the freedom to respond directly to the process of combustion, which allows for a more efficient engine with much quicker response times.

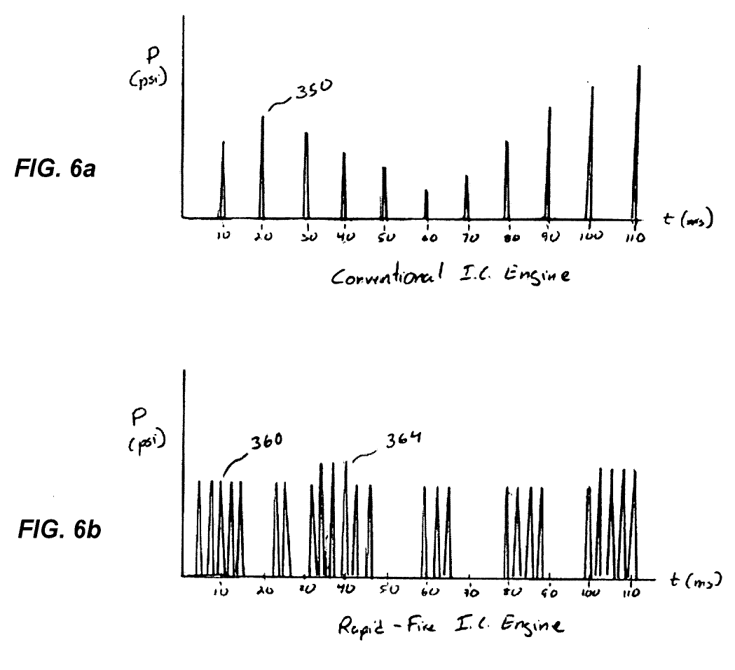

FIGS. 6a and 6b further illustrate the superior physical response characteristics, such as a wider bandwidth and the capability for pulse width modulation, provided by the rapid-fire external compression engine of the present invention over the response characteristics of a conventional IC engine. Bandwidth, in the power generation sense, is the ability of the engine to quickly respond to a wide range of load conditions. An engine with a wide bandwidth can provide almost instantaneous power to drive a heavy load for a short period of time, immediately stop operation when the load is removed, and moments later start up again to provide a sustained power output for lengthy period of time. Pulse width modulation involves the modulation of the duty cycle of the engine manifested by a series of rapid fire pulses (or periodic groups of pulses), thus giving operators the ability to control the overall performance of the driven system to which the engine is connected.

FIG. 6a is a plot of combustion chamber pressure (P) against time (t) of a conventional IC engine operating at 3000 revolutions per minute. At this speed, the combustion chamber is able to fire every 10 milliseconds. Depending on the amount of fuel introduced into the combustion chamber, the combustion chamber pressure 350 will rise to different levels, with a greater amount a fuel resulting in higher peak combustion pressures. The area underneath the pressure spikes is proportional to the amount of energy available for work output by the engine. Due to the mechanical constraints of having a drive piston connected to a crankshaft, at 3000 rpm the drive piston is only in a position to fire once very 10 milliseconds. The engine can be controlled to increase the combustion pressure, which will have the ultimate affect of increasing the speed of the engine (not shown). But even with a highly responsive conventional IC engine, it will take a significant amount of time (more than 500 ms) to increase the amount of energy available as work output, and even then the ultimate speed is normally limited by the mechanical characteristics of the engine to less than 6000 revolutions per minute.

In contrast, FIG. 6b shows the combustion chamber pressure (P) against time (t) of the rapid-fire external compression engine of the present invention. As the engine is not tied to a crankshaft rotating at relatively constant speed, the engine is free to fire as quickly, as often, and at whatever power level the system demand requires. As illustrated in FIG. 6b, the cycle response of the rapid-fire engine is more closely aligned with the timing of the cycle of combustion, which can take place in 3 milliseconds or less. Thus when comparing a conventional IC engine against a rapid-fire external compression engine of equal size, the rapid-fire engine is able fire three to four times as often, resulting in a significantly greater power output. Furthermore, the rapid-fire engine is able to start and stop at any moment in time, enabling precisely controlled power outputs that can be tailored to closely match dynamic load requirements. Finally, while the normal peak pressure 360 is optimized for maximum efficiency, if the engine's rapid-fire ability alone is insufficient to meet load requirements, the ignition controller 112 (not shown) can adjust the ignition set point to allow a greater charge of fuel into the combustion chamber, which will result in higher peak pressures 364 and an increased power output.

Furthermore, a person of ordinary skill in the art will readily recognize that the fuel controller 50 (not shown) and ignition controller 112 (not shown) may together or separately control the operation and power output of the rapid-fire engine at any point in time so as to provide frequency modulation and even frequency, pulse width modulation, or, even frequency, amplitude modulation. Such ability to extract energy and then rapidly stop extracting, and then again rapidly extract energy at any moment in time provides a favorable bandwidth far superior to the bandwidth of the energy extraction and conversion of a conventional IC engine.

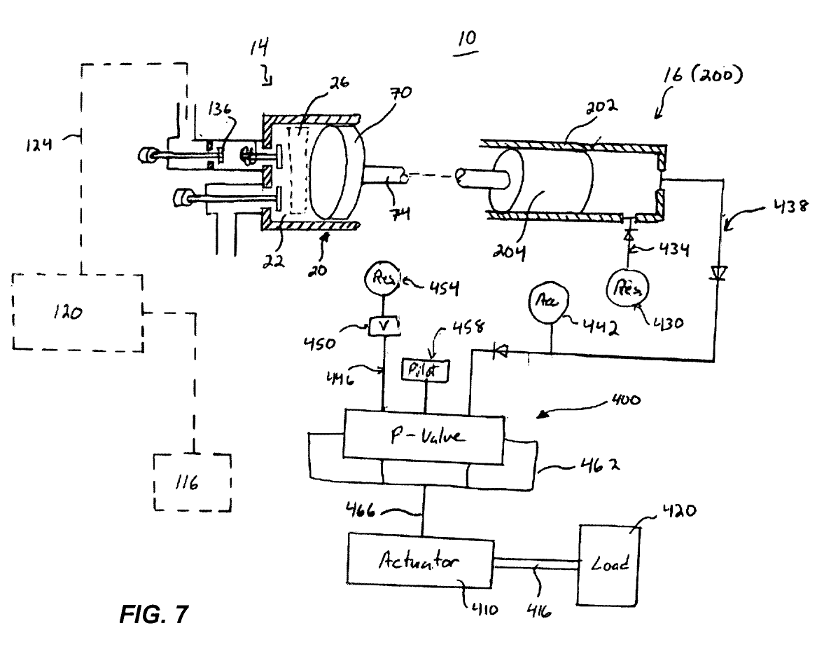

FIG. 7 illustrates a block diagram associated with various partial schematic side views, depicting the use of a single exemplary rapid-fire rapid-response power conversion system utilized to power a pump that drives a single actuator attached to a load, which collectively may be referred to herein as a powered actuator system. In this embodiment, a rapid-fire external compression engine 14 is used to actuate or drive a rapid-response device 16 shown as hydraulic system 200. In one aspect, the external compression engine may comprise a remote compressor 120 that receives fuel from fuel source 116, compresses it, and transfers it into the combustion portion 26 proximate to the head end 22 of a combustion chamber 20 through fuel/oxidizer line 124, also as discussed above.

In the embodiment shown, and upon combustion, the parasite piston 70 is caused to actuate the hydraulic piston 204 within hydraulic chamber 202. Therefore, upon combustion, the rapid-response device 16 is used to pump pressurized fluid, and particularly hydraulic fluid, through pressure line 438 into a pressure control valve 400. The pump operates to receive hydraulic fluid from a hydraulic reservoir 430 through reservoir line 434. Upon being actuated or powered by the external compression engine, the hydraulic system 200 charges the accumulator 442, which is configured to provide the pressure control valve with hydraulic fluid under various select pressures.

The pressure control valve 400 comprises a pressure inlet fluidly coupled to hydraulic pressure line 438, and a return inlet fluidly coupled to return reservoir 454, which return line 446 is controlled by return valve 450. Also fluidly coupled to the pressure control valve is a pilot valve 458 configured to provide a first stage pressure to the pressure control valve 400. Extending from the pressure control valve 400 is a main line 462 that is in fluid communication with load pressure feedback ports formed in opposite sides of the pressure control valve 400, as well as pressure and return outlet ports also formed in the pressure control valve 400 and that communicate with pressure and return inlet ports upon the selective positioning of first and second spools (not shown) strategically supported within the pressure control valve 400. The main line 462 is in further fluid communication with a load feed line 466 that is in turn in fluid communication with a load 420 acting through load support 416 and actuator 410.

The specific functionality of the hydraulic pump 200, the pressure control valve 400, and the actuator 410 are more specifically set forth in U.S. Pat. No. 7,308,848, filed Dec. 1, 2005, and entitled “Pressure Control Valve Having Intrinsic Feedback System,” which is incorporated by reference in its entirety herein.

In the configuration shown, the rapid-fire rapid-response power conversion system 10 is used to drive the actuator 410, which in turn drives the load 420. The rapid-fire external compression engine 14 is capable of generating large amounts of energy in quick bursts or in a more steady or constant manner, depending upon the activation of the fuel control valve 136 and the timing of engine ignition through controller 112 (not shown). This rapid energy generation function is transferred or converted through the rapid power conversion system 16 to achieve rapid output power that is used to power the hydraulic pump. The hydraulic pump rapidly responds by providing the necessary pressure into the pressure control valve 400 to accurately and timely drive the actuator 410 and ultimately the load 420. The use of a rapid-fire rapid-response power conversion system is advantageous in this respect in that the actuator is capable of driving the load using large amounts of power received in short amounts of time and on demand. Therefore, there are few losses in the system between the external compression engine and the actual driving of the actuator and load, as well as an increase in output power. For example, without describing the specific functions of the pilot and pressure control valves, if the load 420 was to be continuously driven or held in place to overcome gravitational forces, the rapid-fire external compression engine could be continuously activated to produce constant energy that may be converted into usable power by the power conversion system. The pump would be continuously operated to supply the necessary pressurized hydraulic fluid needed to sustain the actuator in the drive mode.

In another example, if the actuator 410 was to be actuated and the load 420 driven periodically (either randomly or in systematic bursts), the rapid-fire external compression engine could be periodically activated to produce rapid bursts of energy. In this example, the pump would be periodically operated to supply the necessary pressurized hydraulic fluid needed to drive the actuator for a specified or pre-determined amount of time. The advantage of the rapid-fire external compression engine coupled with the rapid response and energy extraction of the power conversion device, the system is capable of producing large and explosive amounts of output power in a short amount of time over prior related four cycle or four stroke systems.

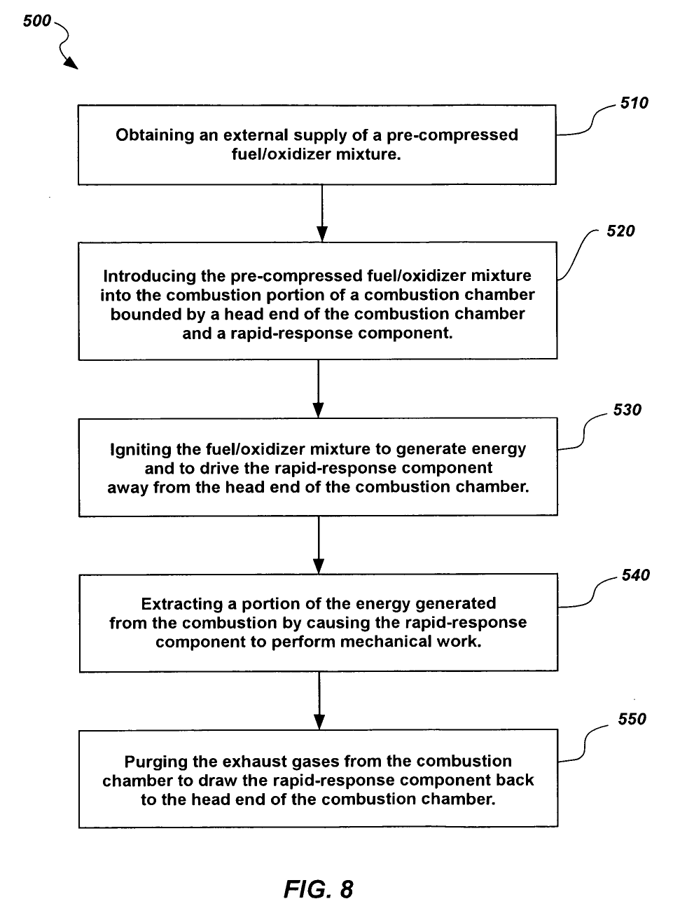

Shown in the flow chart of FIG. 8 is a method 500 of operating a rapid-fire external compression engine. The method can include the steps of obtaining 510 an external supply of a pre-compressed fuel/oxidizer mixture, and introducing 520 the pre-compressed fuel/oxidizer mixture into a combustion portion of a combustion chamber bounded by a head end of the combustion chamber and a rapid-response component. The method can further include the operations of igniting 530 the pre-compressed fuel/oxidizer mixture enclosed in the combustion portion to generate energy and drive the rapid-response component away from the head end of the combustion chamber, and extracting 540 a portion of the energy generated from the combustion by causing the rapid-response component to perform mechanical work. The method can also include the step of purging 550 the exhaust gases from the combustion chamber to draw the rapid-response component back to the head end of the combustion chamber, allowing the cycle to repeat itself as long as the pre-compressed fuel/oxidizer mixture is available for introduction into the combustion chamber.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function limitation are expressly recited in the description herein. Accordingly, the scope of the invention should be determined solely by the appended claims and their legal equivalents, rather than by the descriptions and examples given above.

What is claimed and desired to be secured by Letters Patent is:

1. A rapid-fire external compression engine comprising:
a combustion chamber having a combustion portion proximate to a head end of the combustion chamber;
an intake device in fluid communication with the combustion chamber, the intake device being configured to introduce a pre-compressed fuel/oxidizer mixture into the combustion chamber through at least one fluid intake port, wherein a pressure of the pre-compressed fuel/oxidizer mixture is suitable to facilitate combustion without the need for further compression within the combustion chamber;
an ignition source for selectively timing a combustion of the pre-compressed fuel/oxidizer mixture, wherein the combustion functions to generate energy in the combustion chamber;
a rapid-response component situated adjacent to and in fluid communication with the combustion portion of the combustion chamber, the rapid-response component configured to extract a portion of the energy generated from the combustion; and
an out-take device in fluid communication with the combustion chamber, the out-take device configured to purge exhaust gasses from the combustion chamber through at least one fluid out-take port.

2. The rapid-fire external compression engine of claim 1, wherein the external source of a pre-compressed fuel/oxidizer mixture comprises a remote air compressor in fluid communication with a fuel source to provide the pre-compressed air/fuel mixture to the intake device.

3. The rapid-fire external compression engine of claim 1, wherein the at least one fluid intake port is formed in the head end of the combustion chamber.

4. The rapid-fire external compression engine of claim 1, wherein the intake device comprises a first chamber in fluid communication with the external source of pre-compressed fuel/oxidizer mixture and at least once second chamber, wherein the first chamber and the at least one second chamber are separated by a fuel control valve.

5. The rapid-fire external compression engine of claim 4, wherein the at least one second chamber of the intake device is in fluid communication with the combustion chamber through the at least one intake port, wherein the at least one intake port between the least one second chamber and the combustion chamber is controlled by at least one intake valve.

6. The rapid-fire external compression engine of claim 5, wherein the at least one intake valve is configured to be biased in the open position.

7. The rapid-fire external compression engine of claim 1, wherein the out-take port comprises an exhaust port and an exhaust valve formed in the head end of the combustion chamber.

8. The rapid-fire external compression engine of claim 1, wherein the rapid-response component is a parasite piston disposed in the combustion chamber, the piston comprising an energy receiving portion and the energy transfer component, the energy receiving portion configured to draw the portion of the energy from the combustion in the combustion chamber.

9. The rapid-fire external compression engine of claim 8, wherein the parasite piston comprises a low-inertia piston, wherein the low-inertia piston is configured to displace in response to the introduction of the pre-compressed fuel/oxidizer mixture into the combustion chamber and to facilitate a rapid response to combustion after the pre-compressed fuel/oxidizer mixture has been ignited.

10. The rapid-fire external compression engine of claim 8, wherein the position of the parasite piston is monitored using a displacement measurement device a portion of which is mounted adjacent to the parasite piston.

11. The rapid-fire external compression engine of claim 10, wherein the displacement measurement device is an LVDT (Linear Variable Differential Transformer).

12. The rapid-fire external compression engine of claim 10, wherein the ignition of the pre-compressed fuel/oxidizer mixture in the combustion chamber is controlled according to the position of the parasite piston as measured by the displacement measurement device.

13. The rapid-fire external compression engine of claim 1, wherein the ignition of the pre-compressed fuel/oxidizer mixture in the combustion chamber is based on a parameter selected from the group consisting of a volumetric flow of the mixture into the combustion chamber, timing of the flow of the mixture into the combustion chamber, and a pressure of the mixture within the combustion chamber.

14. The rapid-fire external compression engine of claim 8, wherein the velocity of the parasite piston is monitored using a velocity measurement device, a portion of which is mounted adjacent to the parasite piston.

15. The rapid-fire external compression engine of claim 14, wherein the velocity measurement device is an LVDT (Linear Variable Differential Transformer).

16. The rapid-fire external compression engine of claim 14, wherein the opening of the out-take port in the combustion chamber is controlled according to the velocity of the parasite piston as measured by the velocity measurement device.

17. The rapid-fire external compression engine of claim 9, wherein the rapid-response component is configured to provide greater response bandwidth than a response bandwidth supplied by a conventional internal combustion engine.

18. The rapid-fire external compression engine of claim 9, wherein the rapid-response component draws at least 90% of the portion of the energy generated from the combustion.

19. A rapid-fire rapid-response power conversion system for providing instantaneous, controllable power comprising:
a rapid-fire external compression engine comprising:
a combustion chamber having a combustion portion proximate to a head end of the combustion chamber;
an intake device in fluid communication with the combustion chamber, the intake device being configured to introduce a pre-compressed fuel/oxidizer mixture into the combustion chamber through at least one fluid intake port, wherein a pressure of the pre-compressed fuel/oxidizer mixture is suitable to facilitate combustion without the need for further compression within the combustion chamber;
an ignition source for selectively timing a combustion of the pre-compressed fuel/oxidizer mixture, wherein the combustion functions to generate energy in the combustion chamber;
a rapid-response component situated adjacent to and in fluid communication with the combustion portion of the combustion chamber, the rapid-response component configured to extract a portion of the energy generated from the combustion; and
an out-take device in fluid communication with the combustion chamber, the out-take device configured to purge exhaust gasses from the combustion chamber through at least one fluid out-take port; and
an energy transfer component configured to receive the mechanical work in the rapid-response component and convert it into usable output power for the operation of a powered device.

20. The rapid-fire rapid-response power conversion system of claim 19, wherein said energy transfer component is configured to convert said mechanical work into at least one form of usable energy selected from the group consisting of hydraulic energy, pneumatic energy, electric energy and mechanical energy.

21. The rapid-fire rapid-response power conversion system of claim 19, wherein said powered device is selected from the group consisting of a hydraulic system, a pneumatic system, an electric generator system, and a mechanical system.

22. The rapid-fire rapid-response power conversion system of claim 19, wherein said rapid-response component is coupled to a load selected from the group consisting of a hydraulic system, a pneumatic system, an electric generator system and a mechanical system.

23. The rapid-fire rapid-response power conversion system of claim 19, wherein said energy transfer component comprises a pump piston configured to power a pump, said pump in fluid communication with an actuator and configured to drive said actuator and a load coupled to said actuator.

24. The rapid-fire rapid-response power conversion system of claim 19 wherein said rapid-response component is configured to displace at variable lengths based at least in part on said energy transfer element coupled to said rapid-response component.

25. A method for operating a rapid-fire external compression engine comprising;
obtaining an external supply of a pre-compressed fuel/oxidizer mixture;
introducing the pre-compressed fuel/oxidizer mixture into a combustion portion of a combustion chamber at a pressure suitable to facilitate combustion without the need for further compression within the combustion chamber; the combustion portion being bounded by a head end of the combustion chamber and a rapid-response component;
igniting the pre-compressed fuel/oxidizer mixture enclosed in the combustion portion to initiate a combustion of the pre-compressed fuel/oxidizer mixture to generate energy and drive the rapid-response component away from the head end of the combustion chamber;
causing the rapid response component to extract a portion of the energy generated from the combustion; and
purging the exhaust gases from the combustion chamber to draw the rapid-response component back to an initial position.

26. The method of claim 25, wherein the step of introducing the pre-compressed fuel/oxidizer mixture comprises varying the timing and charge of the pre-compressed fuel/oxidizer mixture introduced into the combustion chamber to achieve varied outputs of the rapid-fire external compression engine.

27. The method of claim 25, wherein the step of introducing the pre-compressed fuel/oxidizer mixture comprises selectively operating an intake device to control the introduction of the pre-compressed fuel/oxidizer mixture into the combustion portion of the rapid-fire external compression engine.

28. The method of claim 25, further comprising repeating each of the combined steps of obtaining, introducing, igniting, causing and purging at different intervals to vary the output of the rapid-fire external compression engine.

29. The method of claim 25, wherein the step of igniting the pre-compressed fuel/oxidizer mixture is based on a displacement position of the parasite piston corresponding to a specific charge of the pre-compressed fuel/oxidizer mixture.

30. The method of claim 25, wherein the step of igniting the pre-compressed fuel/oxidizer mixture is based on a parameter selected from the group consisting of a displacement position of the parasite piston, a pressure within the combustion chamber, a volume of pre-compressed fuel/oxidizer mixture within the combustion chamber, and any combination of these.

31. The method of claim 25, wherein the step of igniting is based upon the presence of a charge of the pre-compressed fuel/oxidizer mixture within the combustion chamber.

32. The method of claim 25, wherein said step of obtaining a pre-compressed fuel/oxidizer mixture comprises obtaining the pre-compressed fuel/oxidizer mixture from a pressurized supply bus.

33. A rapid-fire external compression reaction engine comprising:
a reaction chamber having a reaction portion proximate to a head end of the reaction chamber;
an intake device in fluid communication the reaction chamber and with an external source of pressurized non-combustive reactive fuel, the intake device configured to introduce the pressurized non-combustive reactive fuel into the reaction chamber through at least one fluid intake port at a pressure suitable to facilitate combustion without the need for further compression within the combustion chamber;
an trigger source for selectively triggering a reaction of the pressurized non-combustive reactive fuel, wherein the reaction functions to generate energy in the reaction chamber;
a rapid-response component situated adjacent to and in fluid communication with the reaction portion of the reaction chamber, the rapid-response component configured to extract a portion of the energy generated from the reaction and convert it into mechanical work; and
an out-take device in fluid communication with the reaction chamber, the out-take device configured to purge exhaust gasses from the reaction chamber through at least one fluid out-take port.

34. The rapid-fire external compression reaction engine of claim 33, wherein the external source of a pressurized non-combustive reactive fuel comprises a remote pump in fluid communication with a non-combustive reactive fuel source to provide the pressurized non-combustive reactive fuel to the intake device.

35. A rapid-fire rapid-response power conversion system for providing instantaneous, controllable power comprising:
a rapid-fire external compression reaction engine comprising:
a reaction chamber having a reaction portion proximate to a head end of the reaction chamber;
an intake device in fluid communication with the reaction chamber and with an external source of pressurized non-combustive reactive fuel, the intake device configured to introduce the pressurized non-combustive reactive fuel into the reaction chamber through at least one fluid intake port formed in the head end of the reaction chamber at a pressure suitable to facilitate combustion without the need for further compression within the combustion chamber;
an trigger source for selectively triggering a reaction of the pressurized non-combustive reactive fuel, wherein the reaction functions to generate energy in the reaction chamber;
a rapid-response component situated adjacent to and in fluid communication with the reaction portion of the reaction chamber, the rapid-response component configured to extract a portion of the energy generated from the reaction and convert it into mechanical work;
an out-take device in fluid communication with the reaction chamber, the out-take device configured to purge exhaust gasses from the reaction chamber through at least one fluid out-take port; and
an energy transfer component configured to receive the mechanical work in the rapid-response component and convert it into usable output power for the operation of a powered device.
